(19) United States
(12) Patent Application Publication
(10) Pub. No.: US 2023/0156408 A1
(43) Pub. Date: May 18, 2023

(54) Speaker Device Having Built-In Microphone, and Noise Cancellation Method Using Same

(71) Applicant: SIREN ACOUSTICS. INC., Gyeonggi-do (KR)

(72) Inventors: Bonn-Hee Goo, Gyeonggi-do (KR); Seung-Geun Hong, Gyeonggi-do (KR); Dong-Jun Kim, Seoul (KR)

(73) Assignee: SIREN ACOUSTICS. INC., Gyeonggi-do (KR)

(21) Appl. No.: 17/916,922

(22) PCT Filed: Mar. 30, 2021
(86) PCT No.: PCT/KR2021/003920

§ 371 Date: Oct. 4, 2022

(30) Foreign Application Priority Data
Apr. 6, 2020 (KR) 10-2020-0041704

(51) Int. Cl. H04R 9/06; G10K 11/178; H04R 9/02

(52) U.S. Cl. CPC H04R 9/06; G10K 11/17823; H04R 9/025

(57) ABSTRACT

Disclosed herein are a speaker device having a built-in microphone and a noise cancellation method using the same. The speaker device having the built-in microphone includes a microphone module picking up sound from a medium to generate a sound pickup signal, a speaker driver transmitting vibration corresponding to a reverse-phase signal of the sound pickup signal to tire medium, and a controller receiving the sound pickup signal from the microphone module, generating the reverse-phase signal of the sound pickup signal, and transmitting the reverse-phase signal to the speaker driver.

### TECHNICAL FIELD

The present invention relates, in general, to a speaker device having a built-in microphone and a noise cancellation method using the speaker device, and more particularly a speaker device having a built-in microphone and a noise cancellation method using the speaker device, in which sound transmitted to a medium is picked up with a microphone built in the speaker device, and a reverse phase of sound that is picked up is output, thus cancelling noise.

### BACKGROUND ART

Unless otherwise indicated herein, the material described in this section is not the related art for the claims of this application, and is not admitted to fall within the purview of the related art.

It is very difficult to cancel ambience noise, that is, background noise, generated in a space.

The ambience noise may be introduced in all directions, and is naturally amplified or eliminated by reflection or diffraction.

In particular, the ambience noise generated in a general space such as a room, an office, a vehicle, or an airplane, and a personal living space deteriorates the quality of life, and also causes a decrease in work efficiency as well as concentration.

Further, protracted exposure to noise may cause discomfort to a user, whereby, in order to prevent this problem, when headphones or earphones are worn or the volume of a sound system is increased, noise-induced hearing loss may occur, so that a vicious cycle may be repeated.

Generally, the method for cancelling the ambience noise includes a method of insulating or absorbing sound in the space. There is a problem in that it is difficult to perform sound insulation or absorption construction in a general living environment.

Sound insulation or absorption construction may be performed using a product with excellent sound insulation or absorption effect in the process of establishing a space. However, it is difficult to add construction in a state where facility construction is already completed.

Accordingly, there is a need for technology for cancelling ambience noise without additional construction.

### DISCLOSURE

### Technical Problem

An object of the present invention is to efficiently cancel spatial noise by installing a microphone module and a speaker driver at the same point.

Further, an object of the present invention is to prevent the vibration of a speaker driver installed at the same point from being transmitted to a microphone module.

Furthermore, an object of the present invention is to improve the structure of a microphone module, thus improving the pickup rate of sound transmitted to a medium.

Furthermore, an object of the present invention is to improve the structure of a microphone module, thus preventing howling or feedback generated by a speaker driver.

Furthermore, an object of the present invention is to efficiently transmit the vibration of a speaker driver to a medium by fixing the speaker driver to the medium.

Furthermore, an object of the present invention is to improve the structure of a speaker driver, thus setting the output efficiency and sound quality of the speaker driver with a simple operation.

Furthermore, an object of the present invention is to reproduce clear sound with spatial noise cancelled through an additional speaker module.

Furthermore, the present invention is not limited to the above-described objects, and it is obvious that other objects may be derived from the following description,

### Technical Solution

In accordance with an aspect of the present invention to accomplish the above objects, there is provided a speaker device having a built-in microphone including a microphone module configured to pick up sound from a medium to generate a sound pickup signal, a speaker driver configured to transmit vibration corresponding to a reverse-phase signal of the sound pickup signal to the medium, and a controller configured to receive the sound pickup signal from the microphone module, generate the reverse-phase signal of the sound pickup signal, and transmit the reverse-phase signal to the speaker driver.

Here, the microphone module may include a high-pitched contact microphone configured to pick up sound from the medium using a first band as a target band, and generate a first sound pickup signal, a low-pitched contact microphone configured to pick up sound from the medium using a second band, which is a frequency band lower than the first band, as the target band, and generate a second sound pickup signal, and a microphone controller configured to generate the sound pickup signal by summing the first sound pickup signal and the second sound pickup signal.

Here, the microphone module may further include a feedback blocking housing configured to accommodate the high-pitched contact microphone and the low-pitched contact microphone, the feedback blocking housing being formed of an anti-magnetic material to prevent an influence of external magnetism and formed in a parabolic shape to improve a sound pickup rate.

Here, the microphone module may further include, in order to improve the pickup rate of sound transmitted from the medium, a funnel-shaped high-pitched boost plate configured to contact at a first end thereof with the medium and transmit the vibration of the medium to the high-pitched contact microphone through a second end thereof, and a donut-shaped low-pitched boost plate configured to contact at a first end thereof with the medium and transmit the vibration of the medium to the low-pitched contact microphone through a second end thereof.

Here, the feedback blocking housing may include a rubber plate including one or more through holes arranged at regular intervals along an arc thereof, and covering an opening that is in contact with the medium, the high-pitched boost plate may transmit vibration to the high-pitched contact microphone with the rubber plate interposed therebetween, and the low-pitched boost plate may be positioned inside the rubber plate, and include one or more protrusions corresponding to the through holes, the protrusions being positioned to pass through the through holes.

Here, the speaker driver may include a vibrator contacting on a surface thereof with the medium to transmit vibration thereto, a magnet configured to transmit the vibration to the vibrator, a voice coil positioned outside the magnet to be spaced apart therefrom, and configured to generate a magnetic field in response to the reverse-phase signal, a voice-coil fixing part configured to fix a position of the voice coil outside the voice coil, and a fixing bracket fixed at a first end thereof to the voice-coil fixing part and fixed at a second end thereof to the medium so as to prevent a position of the voice coil relative to the medium from being changed.

Here, the vibrator may include on a surface thereof contacting the medium a microphone holding part recessed inwards, and the microphone module may be positioned in the microphone holding part to be spaced apart from the vibrator.

Here, the speaker device may further include a microphone module supporting pole fixedly coupled at a first end thereof to the microphone module, and coupled at a middle portion thereof to the speaker driver, wherein the microphone module supporting pole and the speaker driver may be coupled to each other with a rubber ring interposed therebetween, so as to prevent the vibration of the speaker driver from being transmitted to the microphone module.

Here, the speaker driver may further include a voice-coil support part positioned inside the voice-coil fixing part and including a fixing groove formed on an inner circumference thereof to fix the voice coil and a first thread formed on an outer circumference thereof, the voice coil may be fixed in the fixing groove, and a second thread may be formed on an inner circumference of the voice-coil fixing part to correspond to the first thread, so that a position of the voice-coil support part is changed by rotation of the voice-coil fixing part.

Here, the speaker device may further include a speaker module oriented in a direction opposite to the microphone module and configured to generate sound in response to a signal applied by a user.

Here, the speaker driver may further include a wave spring positioned on a surface of the magnet so that the magnet returns to an original position thereof after vibration, and having multiple layers formed such that a thickness thereof is increased in proportion to a distance from the magnet.

In accordance with an aspect of the present invention to accomplish the above objects, there is provided a noise cancellation method through a speaker device having a built-in microphone in which a speaker and a microphone are integrated with each other, the noise cancellation method including receiving a sound pickup signal from a medium through the microphone, generating a reverse-phase signal of the sound pickup signal, and transmitting vibration corresponding to the reverse-phase signal to the medium through the speaker having a shape of accommodating the microphone.

Here, an output generated through the speaker may be prevented from being input into the microphone by a parabolic feedback blocking housing that accommodates the microphone.

Here, the feedback blocking housing may be formed of an anti-magnetic material.

Here, the feedback blocking housing may be accommodated in the vibrator of the speaker that transmits vibration to the medium.

Here, the feedback blocking housing may be coupled to be spaced apart from the vibrator by a microphone supporting pole, and the vibration of the vibrator is not transmitted to the microphone by a rubber ring interposed between the microphone supporting pole and the vibrator.

Here, receiving the sound pickup signal may include generating a first phase signal of a balanced audio signal using a signal received from a high-pitched contact microphone of the microphone, generating a second phase signal of the balanced audio signal using a signal received from a low-pitched contact microphone of the microphone, generating a summed sound pickup signal by applying a reverse phase to either of the first phase signal and second phase signal of the balanced audio signal, and receiving the sound pickup signal.

### Advantageous Effects

In accordance with the present invention having the above configuration, it is possible to efficiently cancel spatial noise by installing a microphone module and a speaker driver at the same point.

Further, according to the present invention, it is possible to prevent the vibration of a speaker driver installed at the same point from being transmitted to a microphone module.

Furthermore, according to the present invention, it is possible to improve the structure of a microphone module, thus improving the pickup rate of sound transmitted to a medium.

Furthermore, according to the present invention, it is possible to improve the structure of a microphone module, thus preventing howling or feedback generated by a speaker driver.

Furthermore, according to the present invention, it is possible to efficiently transmit the vibration of a speaker driver to a medium by fixing the speaker driver to the medium.

Furthermore, according to the present invention, it is possible to improve the structure of a speaker driver, thus setting the output efficiency and sound quality of the speaker driver with a simple operation.

Furthermore, according to the present invention, it is possible to reproduce clear sound with spatial noise cancelled through an additional speaker module.

Effects of the present embodiments are not limited to the above-mentioned effects, and other effects that are not mentioned will be clearly understood by those skilled in the art from the description of the claims.

### DESCRIPTION OF DRAWINGS

FIG. 1 is a sectional view illustrating a speaker device having a built-in microphone according to an embodiment of the present invention;

FIG. 2 is an exploded view illustrating the speaker device having a built-in microphone according to an embodiment of the present invention;

FIG. 3 is an exploded view illustrating a microphone module according to an embodiment of the present invention;

FIG. 4 is an exploded view illustrating a speaker driver according to an embodiment of the present invention;

FIG. 5 is a processing flow diagram of using a single device according to an embodiment of the present invention;

FIG. 6 is a processing flow diagram of using multiple connections according to an embodiment of the present invention;

FIG. 7 is a diagram illustrating the use of the apparatus attached to the interior of a vehicle according to an embodiment of the present invention;

FIG. 8 is a diagram illustrating a noise cancelling area according to an embodiment of the present invention;

FIG. 9 is a sectional view of a device with a speaker for reproducing sound added, according to an embodiment of the present invention; and

FIG. 10 is a flowchart of a noise cancelling method according to an embodiment of the present invention.

### BEST MODE

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

The basic condition of a noise cancelling method is to generate a reverse-phase wavelength at the same position as a position where noise is generated, thus cancelling the wavelength.

When a noise source is blocked by a wall or obstacle, a point at which noise is generated may be regarded as the wall or obstacle, and the reverse-phase wavelength may be generated at the wall or obstacle to cancel noise.

In this case, a speaker driver may be used as a device for reproducing sound, and a microphone module for picking up noise is also required.

The microphone module may pick up noise, perform reverse-phase processing for the picked up signal, and transmit the signal to the speaker driver. The speaker driver may output the signal subjected to the reverse-phase processing to cancel noise.

However, sound reproduced through the speaker driver may be picked up by the microphone module, and the picked up sound may be amplified through an amplifier and then output again by the speaker driver.

This is referred to as howling or feedback. The feedback may easily occur when the microphone module is positioned on-axis with respect to a voice coil of the speaker driver.

Therefore, the speaker driver and the microphone module cannot be generally installed at the same position.

Moreover, the feedback continuously increases the amplification amount of the amplifier, thus causing damage to an amplifier circuit, a power circuit, and a speaker driver.

The feedback may be easily generated at a specific frequency, and may affect a full frequency band as the bandwidth of a quality factor (Q) value is widened.

Therefore, there is a need for a method of preventing the feedback by blocking a frequency in which the feedback occurs using a graphic equalizer (EQ).

However, the above-described method is problematic in that it may change the characteristics of the frequency and the reverse phase of the input frequency may be precisely processed, so that it is difficult to use the method in a noise cancelling environment.

Furthermore, when the microphone module and the speaker driver are installed at distinct positions so as to prevent feedback, noise that is to be cancelled through the microphone module cannot be precisely picked up, and should be corrected through a Digital Signal Processor (DSP).

The feedback occurs because both the speaker driver and the microphone module have certain directivity. Thus, in order to prevent the feedback, it is advantageous to position the speaker driver and the microphone module in an off-axis state.

However, as described above, the off-axis state makes it impossible to pick up the correct sound, so that there is a need for a method in which the speaker driver and the microphone module are positioned in the on-axis state, while preventing the feedback.

Thus, according to an embodiment of the present invention, a cover capable of blocking a magnetic field so as to prevent feedback even on the on-axis is used as a cover of the microphone module, and it is possible to prevent feedback by positioning the microphone module inside a diaphragm of the speaker driver.

Hereinafter, a preferred embodiment of the present invention will be described in detail with reference to the accompanying drawings.

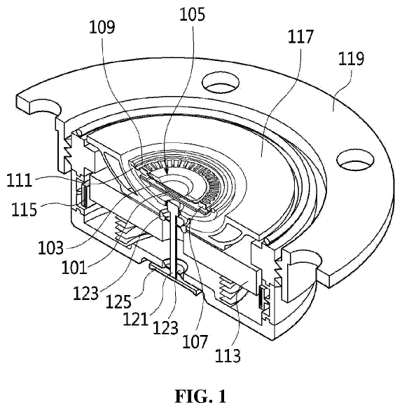

FIG. 1 is a sectional view illustrating a speaker device having a built-in microphone according to an embodiment of the present invention.

Referring to FIG. 1, the speaker device having a built-in microphone according to an embodiment of the present invention may include a microphone module that picks up sound from a medium to generate a sound pickup signal, a speaker driver that transmits a vibration corresponding to a reverse-phase signal of the sound pickup signal to the medium, and a controller that receives the sound pickup signal from the microphone module, generates the reverse-phase signal of the sound pickup signal, and transmits the reverse-phase signal to the speaker driver.

Here, the microphone module may include a high-pitched contact microphone 101, a low-pitched contact microphone 103, a high-pitched boost plate 105, a low-pitched boost plate 107, a rubber plate 109, and a feedback blocking housing 111.

The speaker driver may include a magnet 113, a voice coil 115, a vibrator 117, and a fixing bracket 119.

According to an embodiment of the present invention, in order to efficiently cancel spatial noise, the speaker driver may be installed in the same position as the position of the microphone module.

The reason why the speaker driver is installed in the same position as the microphone module is because a pickup position is set to be the same as a reproduction position, so that the processing power for correcting a phase difference that may occur when the speaker driver and the microphone module are at different positions is reduced, and an error is minimized.

To this end, an embodiment of the present invention may propose one device, in which the microphone module is disposed in the speaker driver for creating a vibration, and a feedback prevention structure is applied, thus being capable of picking up a noise signal and simultaneously reproducing a reverse-phase signal.

In detail, the vibrator 117 of the speaker driver may have a parabolic shape, and the microphone module may be mounted therein to separately pick up high-pitched sound and low-pitched sound.

In this regard, the microphone module may be structurally separated so as not to be affected by the vibration of the speaker driver.

In detail, the vibrator 117 of the speaker driver may include on a surface contacting the medium a microphone holding part recessed inwards, and the microphone module may be positioned in the microphone holding part to be spaced apart from the vibrator 117.

Furthermore, the apparatus may further include a microphone module supporting pole 121 that is fixedly coupled at one end thereof to the microphone module and coupled at a middle portion thereof to the speaker driver so as to prevent the vibration of the speaker driver from being transmitted to the microphone module. A rubber ring 123 may be interposed between the microphone module supporting pole 121 and the speaker driver.

Through the above-described structure, according to an embodiment of the present invention, the microphone module and the speaker driver are precisely seated on the medium, so that pickup and reproduction can be arranged to be completely independently operated.

Furthermore, the microphone module supporting pole 121 may allow the microphone module to be precisely adsorbed to the medium, and may be firmly attached to a target medium using an adhesive on the rubber plate 109.

The feedback blocking housing 111 may accommodate the high-pitched contact microphone 101 and the low-pitched contact microphone 103, may be formed of an anti-magnetic material (magnetic shielding) to prevent the influence of external magnetism, and may be formed in the parabolic shape to improve a sound pickup rate.

Furthermore, an embodiment of the present invention may include an integration terminal 125 for connecting the speaker driver and the microphone module.

Here, the microphone module may use piezo diaphragms of different sizes like the high-pitched contact microphone 101 and the low-pitched contact microphone 103 to differently pick up the center frequency of sound to be picked up.

This can increase the range of a target sound pickup frequency band.

According to an embodiment of the present invention, the microphone module for picking up sound is installed in the same position as a position where the speaker driver is installed, but the microphone module may pick up only noise on a contact surface without picking up noise in the air using a contact microphone (e.g. piezo microphone), thus preventing feedback.

Furthermore, as described above, the microphone module includes the magnetic shielding feedback blocking housing to prevent the magnetic field of the speaker driver from affecting the module and thereby preventing the feedback due to the magnetic field.

Here, the vibrator 117 may be connected to the magnet 115, and vibration may be transmitted through the vibrator 117 to the medium in a moving magnetic driving method.

At this time, the vibration of the vibrator 117 may not affect the microphone module through the rubber ring 123.

The fixing bracket 119 may be connected to a voice-coil fixing part of the speaker driver or an external housing of the speaker driver to be fixed to the medium.

In this case, the microphone module and the vibrator 117 may be horizontally mounted on the medium by the fixing bracket 119.

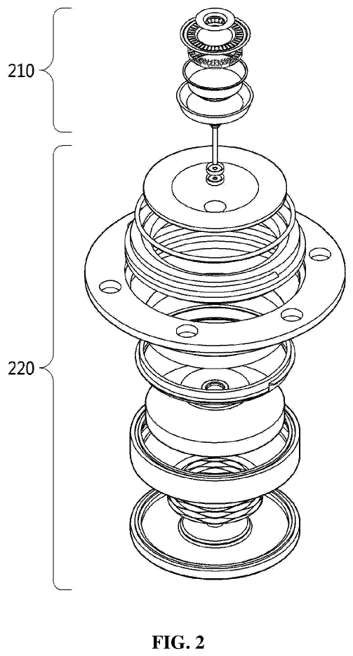

FIG. 2 is an exploded view illustrating the speaker device having a built-in microphone according to an embodiment of the present invention.

Referring to FIG. 2, the speaker device having the built-in microphone according to an embodiment of the present invention may include a microphone module 210 and a speaker driver 220.

As shown in FIG. 2, the microphone module 210 and the speaker driver 220 may be configured such that respective components are stacked and coupled, and may be formed such that the microphone module 210 is coupled to the inside of the speaker driver 220.

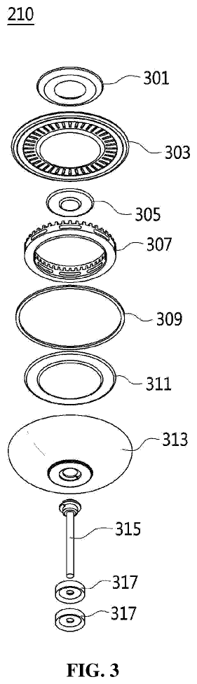

FIG. 3 is an exploded view illustrating the microphone module according to an embodiment of the present invention.

Referring to FIG. 3, the microphone module 210 according to an embodiment of the present invention may include a high-pitched contact microphone 305 that picks up sound from the medium using a first band as a target band and generates a first sound pickup signal, a low-pitched contact microphone 311 that picks up sound from the medium using a second band, which is a frequency band lower than the first band, as the target band and generates a second sound pickup signal, and a microphone controller that generates the sound pickup signal by summing the first sound pickup signal and the second sound pickup signal.

The first band and the second band may include a crossover band, and the sound pickup signal may correspond to the crossover band.

Here, the high-pitched contact microphone 305 and the low-pitched contact microphone 311 may connect a negative terminal (−) to the same ground, and each may generate a balanced audio signal (the balanced audio signal is resistant to noise characteristics) using a positive terminal (+) as an individual output.

The balanced audio signal also has the effect of amplifying the entire signal.

The signals of sound picked up by the high-pitched contact microphone 305 and the low-pitched contact microphone 311 are summed. At this time, an overlapping crossover area substantially becomes a target band.

In this case, the crossover frequency may be adjusted by a user.

For example, a crossover frequency range may be set in the DSP, and a user may adjust a crossover frequency by designating the high-pitched contact microphone 305 as a High Pass Filter (HPF) and designating the low-pitched contact microphone 311 as a Low Pass Filter (LPF).

Here, the high-pitched contact microphone 305 may have a relatively smaller area than the low-pitched contact microphone 311, and the high-pitched contact microphone 305 and the low-pitched contact microphone 311 may be stacked while being spaced apart from each other so that central axes thereof are aligned with each other.

Furthermore, the microphone module 210 according to an embodiment of the present invention may further include a funnel-shaped high-pitched boost plate 301 that contacts at one end thereof with the medium and transmits the vibration of the medium to the high-pitched contact microphone 305 through the other end so as to improve the pickup rate of sound transmitted from the medium.

The high-pitched boost plate 301 is formed in a funnel shape to amplify micro-vibration and efficiently transmit the amplified vibration to the high-pitched contact microphone 305.

The material of the high-pitched boost plate 301 may use a material (e.g. forming a density to have the same sound propagation speed as ABS-concrete) that may amplify vibration, so that vibration can be efficiently absorbed even in a high-density medium that is difficult to absorb vibration.

Furthermore, the microphone module 210 according to an embodiment of the present invention may further include a donut-shaped low-pitched boost plate 307 that contacts at one end thereof with the medium and transmits the vibration of the medium to the low-pitched contact microphone 311 through the other end so as to improve the pickup rate of sound transmitted from the medium.

The low-pitched boost plate 307 may be positioned such that an outer circumference thereof is aligned with an outer circumference of the low-pitched contact microphone 311, and the high-pitched boost plate 301 may be positioned in an inner through hole of the low-pitched boost plate 307.

Furthermore, the microphone module 210 according to an embodiment of the present invention may further include a feedback blocking housing 313 that accommodates the high-pitched contact microphone 305 and the low-pitched contact microphone 311 and is formed in a parabolic shape so as to improve a sound pickup rate.

In this regard, the feedback blocking housing 313 may be formed in a parabolic shape to amplify sound generated in the medium and pick up only sound generated in a targeted direction.

Furthermore, the feedback blocking housing 313 may be formed of an anti-magnetic material or a magnetic shielding type, so that it is not affected by the magnetic effect of the magnet of the speaker driver as will be described later, thereby eliminating a feedback phenomenon.

Furthermore, the microphone module 210 including the feedback blocking housing 313 is of a contact microphone type that is not affected by acoustic characteristics, so people or ambience noise is not well picked up.

Here, the feedback blocking housing 313 may include a rubber plate 303 covering an opening that is in contact with the medium.

In this regard, the rubber plate 303 may be formed of a material capable of amplifying a targeted frequency band of the medium, and may acquire a targeted frequency by adjusting a size and a thickness.

In this regard, the rubber plate 303 may put its edge on an edge so as to efficiently amplify and pick up the frequency, thus improving responsiveness.

Furthermore, the rubber plate 303 may treat an outer edge in a ring shape so as to pick up correct spot sound.

Through the ring shape, the microphone module 210 according to an embodiment of the present invention may block sound introduced from the outside by compression when the microphone module is mounted on the medium, and may be precisely attached to the medium, so that low-pitched sound pickup characteristics may be increased by increasing proximity effect.

The rubber plate 303 includes one or more through holes arranged at regular intervals along an arc, and the low-pitched boost plate 307 may be positioned inside the rubber plate 303 and may include one or more protrusions corresponding to the through holes of the rubber plate 303, so that the protrusions may be positioned to pass through the through holes of the rubber plate 303.

Here, the high-pitched contact microphone 305 and the low-pitched contact microphone 311 may be at least one of a piezo microphone and a laser microphone.

Furthermore, the speaker device having the built-in microphone according to an embodiment of the present invention may further include a microphone module supporting pole 315 as a component for coupling the microphone module 210 with the speaker driver.

In this regard, the microphone module supporting pole 315 may be fixedly coupled at one end thereof to the feedback blocking housing 313, and may be coupled at a middle portion thereof to the speaker driver.

Here, the feedback blocking housing 313 and the microphone module supporting pole 315 may be formed to have corresponding threads, and may be fastened to each other through a screw-type fastening method.

Furthermore, the speaker device having the built-in microphone according to an embodiment of the present invention may couple the microphone module supporting pole 315 with the speaker driver with the rubber ring 317 interposed therebetween, so as to prevent the vibration of the speaker driver from being transmitted to the microphone module 210.

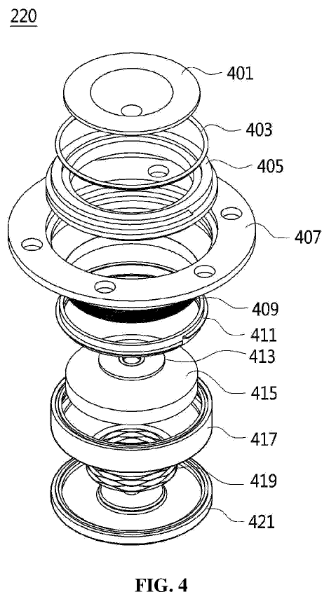

FIG. 4 is an exploded view illustrating a speaker driver according to an embodiment of the present invention.

Referring to FIG. 4, the speaker driver 220 according to an embodiment of the present invention includes a vibrator 401, a magnet 415, a voice coil 409, a voice-coil fixing part 417, and a fixing bracket 407, and is attached to the medium to generate vibration.

The voice coil 409 generates a magnetic field in response to a reverse-phase signal that is applied through the microphone module.

The signal may be a sound signal that is output to the speaker driver 220, and may move the magnet 415 by the magnetic field.

The voice-coil fixing part 417 may accommodate the components, and may fix the position of the voice coil 409 outside the voice coil 409.

The voice-coil fixing part 417 may prevent the position of the voice coil 409 relative to the medium from being changed.

The voice coil 409 may be positioned in the voice-coil fixing part 417, and the position of the voice coil relative to the magnet 415 may be changed.

The reason why the relative position is changed is because sound properties vary depending on the position of the voice coil 409 relative to the magnet 415.

Generally, the voice coil 409 and the magnet 415 should be positioned one-half the center of the voice coil 409. When the voice coil 409 and the magnet 415 move apart from each other, an output is reduced and low-pitched sound is reduced, so that only high-pitched sound is consequently heard. As the voice coil 409 and the magnet 415 come near to each other, an output is increased and low-pitched sound is increased.

Therefore, the speaker driver 220 according to an embodiment of the present invention allows the position of the magnet 415 or the voice coil 409 to be delicately shifted, so that efficiency and sound quality may be adjusted as desired by a user.

The speaker driver 220 according to an embodiment of the present invention further includes a voice-coil support part 411 that is positioned inside the voice-coil fixing part 417, and has a fixing groove formed on an inner circumference thereof to fix the voice coil 409, and a first thread formed on an outer circumference thereof. The voice coil 409 may be fixed in the fixing groove, and may have a second thread formed on the inner circumference of the voice-coil fixing part 417 to correspond to the first thread, so that the position of the voice-coil support part 411 may be changed by the rotation of the voice-coil fixing part 417.

The magnet 415 may be positioned inside the voice coil 409 to be moved by the magnetic field.

In this regard, the movement may be vertical vibration, and the vibration of the magnet 415 may be transmitted to the vibrator 401.

A surface of the vibrator 401 may be in contact with the medium to transmit the vibration to the medium.

The vibrator 401 may be formed in a parabolic shape to include a microphone holding part that is recessed inwards from a surface contacting the medium, and the microphone module may be positioned in the microphone holding part to be spaced apart from the vibrator 401.

A through hole is formed in the center of the vibrator 401, and the microphone module supporting pole passes through the through hole to be fixed by the rubber ring. One end of the microphone module supporting pole may be fixedly coupled to the microphone module or the feedback blocking housing of the microphone module.

A suspension ring 413 may be included to prevent damage due to accumulated shocks by vibration between the vibrator 401 and the magnet 415, and may be formed of a soft material.

A support spring 419 may be positioned on a surface of the magnet 415 so that the magnet 415 may return to its original position after vibration.

The support spring 419 may be a wave spring having multiple layers.

Here, the support spring 419 may make the multiple layers of the wave spring 613 have different thicknesses, thereby increasing a reaction rate at low output and preventing distortion from occurring even at high output.

For example, the wave spring according to an embodiment of the present invention may have a multi-layered structure including a layer a, a layer b, and a layer c, and may be configured such that the thicknesses of the layers are a<b<c.

The wave spring may move only the layer a when small sound of low output is reproduced, and may move the layers a, b, and c together when large sound of high output is reproduced.

Therefore, the wave spring according to an embodiment of the present disclosure has different spring restoring force depending on an output. Thus, even if sound having very strong transient characteristics is instantaneously input, the wave spring does not cause distortion, may have a fast restoring force, and may maximize a damping factor.

Furthermore, the wave spring does not increase the size of a product because its thickness may be reduced by at least ½ compared to the existing spring, and has a very strong restoring force, so that the spring is not deformed even after long-term use.

Furthermore, the speaker driver 220 may further include a top cover 405 and a bottom cover 421 to accommodate each component, and may use the voice-coil fixing part 417 as a side cover.

In order to improve the performance of the speaker driver 220, an aluminum foil may be further provided on an inner surface of the voice coil 409.

The fixing bracket 407 may be fixed at one end thereof to the voice-coil fixing part 417 and fixed at the other end thereof to the medium so as to prevent the position of the voice coil 409 relative to the medium from being changed.

Furthermore, the fixing bracket 407 may be coupled at one end thereof to the top cover 405 to be fixed to the medium.

The thread may be formed on the inner circumference of one end of the fixing bracket 407, and the thread may be formed on the outer circumference of the voice-coil fixing part 417 or the top cover 405 to correspond to the thread of the fixing bracket and engage therewith in a screw-type fastening manner.

Furthermore, the fixing bracket 407 may be formed in a cylindrical shape, and may further include a contact part on the outer circumference of one end of the fixing bracket contacting the medium to extend outwards. The contact part may include at least one through hole to be coupled to the medium.

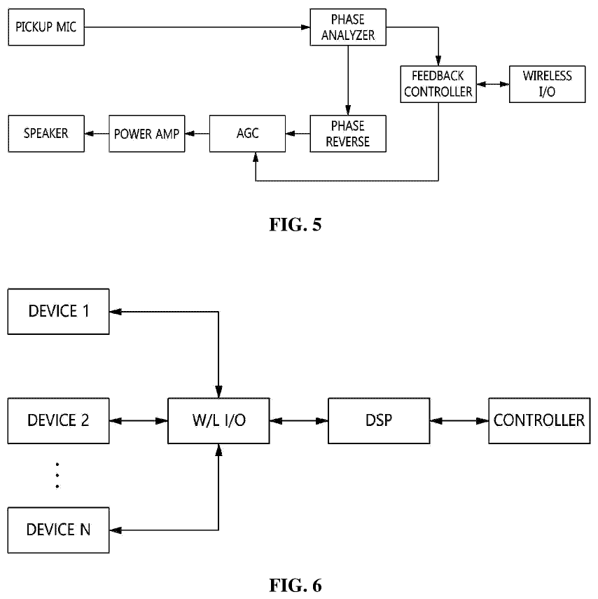

FIG. 5 is a processing flow diagram of using a single device according to an embodiment of the present invention, and FIG. 6 is a processing flow diagram of using multiple connections according to an embodiment of the present invention.

Referring to FIGS. 5 and 6, the speaker device having the built-in microphone according to an embodiment of the present invention may make a reverse-phase signal using an analog circuit in which no latency occurs, amplify the signal and transmit the signal to the speaker driver, so as to prevent a wavelength from being distorted due to latency between the sound pickup of the microphone module and the reproduction of the speaker driver.

The above-described method may reproduce a reverse-phase waveform that is input in real time, and may cancel vibration noise generated in a targeted spot.

In this regard, the targeted spot may be a part that needs noise cancellation selected by a user.

Furthermore, the adjustment of gain and/or phase, the detection of the feedback frequency, etc. may be digitally controlled, if necessary, regardless of an analog circuit.

In this case, the digital control may use a wireless or Bluetooth device, and may use a portable device and a smart device or an infotainment system of a car.

Here, the level of measured noise or cancelled noise may be visually monitored using the above-described device, and may be adjusted to fit for a user's purpose by adjusting a parameter.

As shown in FIG. 5 or FIG. 6, the case of using the single device and the case where multiple devices are connected may be separately operated. When the multiple devices are connected, a processing algorithm may be added according to the connected number, thus making it possible to more efficiently manage a frequency.

According to an embodiment of the present invention, an area where noise is cancelled may be processed with an image by recognizing positions where multiple devices are attached and converting into a distance.

Here, according to an embodiment of the present invention, an effective mounting point may be expected and the mounting point may be guided.

According to an embodiment of the present invention, the processing area of noise cancellation may be imaged, and a user may specify the area within a possible range.

Thus, according to an embodiment of the present invention, a gain controller or the like may be automatically applied.

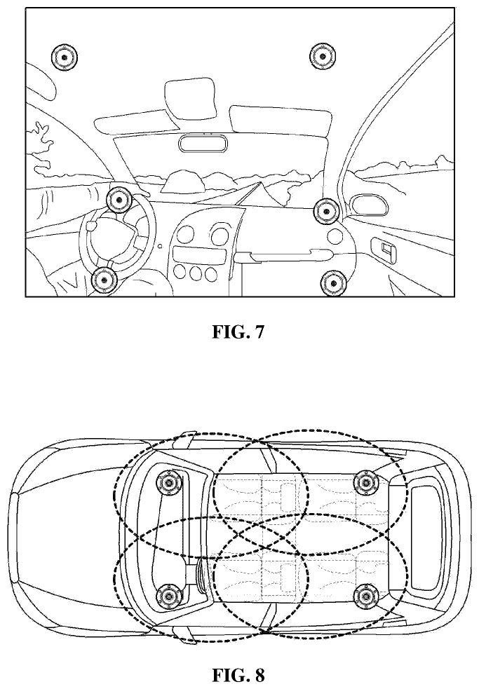

FIG. 7 is a diagram illustrating the use of the apparatus attached to the interior of a vehicle according to an embodiment of the present invention.

Referring to FIG. 7, one or more speaker devices, each having a built-in microphone, according to an embodiment of the present invention may be attached to a space such as the vehicle and then used.

Here, one or more speaker devices, each having a built-in microphone, according to an embodiment of the present invention may be mounted in the lower area of a dashboard, the interior of a ceiling, an A pillar, a trunk hood, or under a chair inside the vehicle, or may be formed in an adsorption type to be mounted on glass or sunroof.

Furthermore, the speaker device having the built-in microphone according to an embodiment of the present invention may be installed and used in any spot or part where vibration may be generated and noise may be introduced, without being limited to the above-described positions.

FIG. 8 is a diagram illustrating a noise cancelling area according to an embodiment of the present invention.

Referring to FIG. 8, an embodiment of the present invention may calculate directivity according to a position where the device is mounted.

According to an embodiment of the present invention, when one or more devices are mounted and used, an area where noise is cancelled may be set, and noise may be controlled to be cancelled within the set area.

In this case, one or more directivity may be generated through a volume control.

Here, an embodiment of the present invention may be implemented in the form of an application. The application may include one or more functions, such as the function of recognizing one or more devices, the function of controlling the volume and phase to set the degree of attenuation, the function of simulating using space through various modes (car mode, room mode, and desktop mode), the function of setting a direction, and the function of detecting a picked-up signal of a microphone to suggest a. point where an optimal attenuation characteristic is expected.

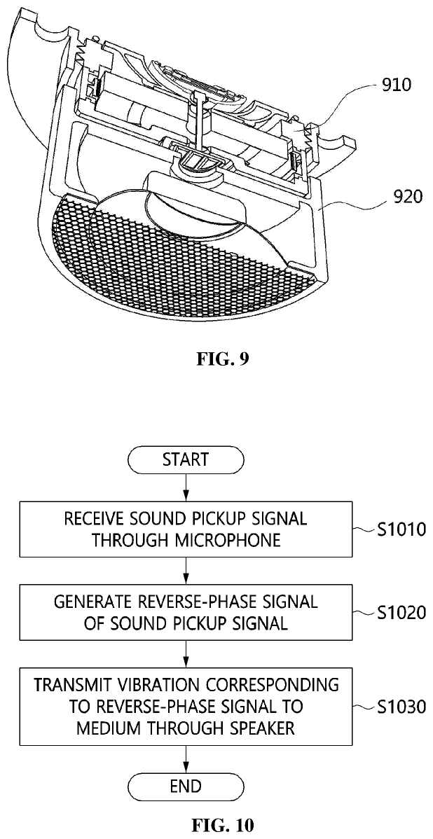

FIG. 9 is a sectional view of a device with a speaker for reproducing sound added, according to an embodiment of the present invention.

Referring to FIG. 9, a speaker device 910 having a built-in microphone according to an embodiment of the present invention may further include a speaker module 920 that generates sound in response to a signal applied by a user in a direction opposite to a surface attached to the medium.

The speaker module 920 may increase the frequency of using the speaker device 910 having the built-in microphone so as to cancel spatial noise, and may reproduce sound having clear sound quality in a state where the spatial noise is cancelled even in a space where noise is generated.

FIG. 10 is a flowchart of a noise cancelling method according to an embodiment of the present invention.

Referring to FIG. 10, the method for cancelling the noise through the speaker device having the built-in microphone in which the speaker and the microphone are integrated according to an embodiment of the present invention first receives a sound pickup signal from the medium through the microphone at step S1010.

In this case, step S1010 may include the step of generating a first phase signal of a balanced audio signal using a signal received from a high-pitched contact microphone, the step of generating a second phase signal of the balanced audio signal using a signal received from a low-pitched contact microphone, the step of generating a summed sound pickup signal by applying a reverse phase to either of the first phase signal and second phase signal of the balanced audio signal, and the step of receiving the sound pickup signal.

Furthermore, the noise cancelling method according to an embodiment of the present invention generates a reverse-phase signal of the sound pickup signal at step S1020.

Furthermore, the noise cancelling method according to an embodiment of the present invention transmits vibration corresponding to the reverse-phase signal to the medium through the speaker having the shape of accommodating the microphone at step S1030.

The output generated through the speaker may be prevented from being input into the microphone by the parabolic feedback blocking housing that accommodates the microphone.

In this case, the feedback blocking housing may be formed of an anti-magnetic material.

The feedback blocking housing may be accommodated in the vibrator of the speaker that transmits vibration to the medium.

The feedback blocking housing may be coupled to be spaced apart from the vibrator by the microphone supporting pole, and the vibration of the vibrator may not be transmitted to the microphone by the rubber ring interposed between the microphone supporting pole and the vibrator.

As described above, the speaker device having the built-in microphone and noise cancellation method using the speaker device according to the present invention are not limited and applied to the configurations and operations of the above-described embodiments, but all or some of the embodiments may be selectively combined and configured such that the embodiments may be modified in various ways.

1. A speaker device having a built-in microphone comprising:
a microphone module configured to pick up sound from a medium to generate a sound pickup signal;
a speaker driver configured to transmit vibration corresponding to a reverse-phase signal of the sound pickup signal to the medium; and
a controller configured to receive the sound pickup signal from the microphone module, generate the reverse-phase signal of the sound pickup signal, and transmit the reverse-phase signal to the speaker driver.

2. The speaker device of claim 1, wherein the microphone module comprises:
a high-pitched contact microphone configured to pick up sound from the medium using a first band as a target band, and generate a first sound pickup signal;
a low-pitched contact microphone configured to pick up sound from the medium using a second band, which is a frequency band lower than the first band, as the target band, and generate a second sound pickup signal; and
a microphone controller configured to generate the sound pickup signal by summing the first sound pickup signal and the second sound pickup signal.

3. The speaker device of claim 2, wherein the microphone module further comprises:
a feedback blocking housing configured to accommodate the high-pitched contact microphone and the low-pitched contact microphone, the feedback blocking housing being formed of an anti-magnetic material to prevent an influence of external magnetism and formed in a parabolic shape to improve a sound pickup rate.

4. The speaker device of claim 3, wherein the microphone module further comprises, in order to improve the pickup rate of sound transmitted from the medium,
a funnel-shaped high-pitched boost plate configured to contact at a first end thereof with the medium and transmit the vibration of the medium to the high-pitched contact microphone through a second end thereof; and
a donut-shaped low-pitched boost plate configured to contact at a first end thereof with the medium and transmit the vibration of the medium to the low-pitched contact microphone through a second end thereof.

5. The speaker device of claim 4, wherein:
the feedback blocking housing comprises a rubber plate including one or more through holes arranged at regular intervals along an arc thereof, and covering an opening that is in contact with the medium,
the high-pitched boost plate transmits vibration to the high-pitched contact microphone with the rubber plate interposed therebetween, and
the low-pitched boost plate is positioned inside the rubber plate, and comprises one or more protrusions corresponding to the through holes, the protrusions being positioned to pass through the through holes.

6. The speaker device of claim 1, wherein the speaker driver comprises:
a vibrator contacting on a surface thereof with the medium to transmit vibration thereto;
a magnet configured to transmit the vibration to the vibrator;
a voice coil positioned outside the magnet to be spaced apart therefrom, and configured to generate a magnetic field in response to the reverse-phase signal;
a voice-coil fixing part configured to fix a position of the voice coil outside the voice coil; and
a fixing bracket fixed at a first end thereof to the voice-coil fixing part and fixed at a second end thereof to the medium so as to prevent a position of the voice coil relative to the medium from being changed.

7. The speaker device of claim 6, wherein:
the vibrator comprises on a surface thereof contacting the medium a microphone holding part recessed inwards, and
the microphone module is positioned in the microphone holding part to be spaced apart from the vibrator.

8. The speaker device of claim 7, further comprising:
a microphone module supporting pole fixedly coupled at a first end thereof to the microphone module, and coupled at a middle portion thereof to the speaker driver,
wherein the microphone module supporting pole and the speaker driver are coupled to each other with a rubber ring interposed therebetween, so as to prevent the vibration of the speaker driver from being transmitted to the microphone module.

9. The speaker device of claim 6, wherein:
the speaker driver further comprises a voice-coil support part positioned inside the voice-coil fixing part, and including a fixing groove formed on an inner circumference thereof to fix the voice coil and a first thread formed on an outer circumference thereof,
the voice coil is fixed in the fixing groove, and
a second thread is formed on an inner circumference of the voice-coil fixing part to correspond to the first thread, so that a position of the voice-coil support part is changed by rotation of the voice-coil fixing part.

10. The speaker device of claim 7, further comprising:
a speaker module oriented in a direction opposite to the microphone module and configured to generate sound in response to a signal applied by a user.

11. The speaker device of claim 6, wherein the speaker driver further comprises:
a wave spring positioned on a surface of the magnet so that the magnet returns to an original position thereof after vibration, and having multiple layers formed such that a thickness thereof is increased in proportion to a distance from the magnet.

12. A noise cancellation method through a speaker device having a built-in microphone in which a speaker and a microphone are integrated with each other, the noise cancellation method comprising:
receiving a sound pickup signal from a medium through the microphone;
generating a reverse-phase signal of the sound pickup signal; and
transmitting vibration corresponding to the reverse-phase signal to the medium through the speaker having a shape of accommodating the microphone.

13. The noise cancellation method of claim 12, wherein an output generated through the speaker is prevented from being input into the microphone by a parabolic feedback blocking housing that accommodates the microphone.

14. The noise cancellation method of claim 13, wherein the feedback blocking housing is formed of an anti-magnetic material.

15. The noise cancellation method of claim 13, wherein the feedback blocking housing is accommodated in the vibrator of the speaker that transmits vibration to the medium.

16. The noise cancellation method of claim 15, wherein the feedback blocking housing is coupled to be spaced apart from the vibrator by a microphone supporting pole, and the vibration of the vibrator is not transmitted to the microphone by a rubber ring interposed between the microphone supporting pole and the vibrator.

17. The noise cancellation method of claim 12, wherein receiving the sound pickup signal comprises:
generating a first phase signal of a balanced audio signal using a signal received from a high-pitched contact microphone of the microphone;
generating a second phase signal of the balanced audio signal using a signal received from a low-pitched contact microphone of the microphone;
generating a summed sound pickup signal by applying a reverse phase to either of the first phase signal and second phase signal of the balanced audio signal; and
receiving the sound pickup signal.
